(19) United States
(12) Patent Application Publication
(10) Pub. No.: US 2002/0008011 A1
(43) Pub. Date: Jan. 24, 2002

(54) Method for the preparation of propylsilanes functionalized in the 3 position

(76) Inventors: Raymund Sonnenschein, Erlensee (DE); Christoph Batz-Sohn, Hanau (DE)

Correspondence Address: SMITH, GAMBRELL & RUSSELL, LLP, 1850 M STREET, N.W., SUITE 800, WASHINGTON, DC, 20036, US

(21) Appl. No.: 09/818,997

(22) Filed: Mar. 28, 2001

Related U.S. Application Data
(60) Provisional application No. 60/192,575, filed on Mar. 28, 2000.

(51) Int. Cl. B01D 3/00; C07F 7/20

(52) U.S. Cl. 203/29; 203/75; 203/77; 203/78; 203/80; 203/DIG. 6; 556/465

(57) ABSTRACT

A method for preparing an organosilane functionalized in the 3 position includes reacting an allyl compound (H₂C═CH—CH₂X) with a silane (R²R³R⁴SiH) in a reaction column under a pressure between 1 bar and 25 bar, in the presence of a heterogeneous platinum catalyst. The silane reactant is present in the reaction column, and introduced into the reaction column, in a stoichiometric excess with respect to the allyl compound. The reaction column preferably includes a reaction zone, a first separation zone located above the reaction zone, and a second separation zone located below the reaction zone, wherein a first product exits the reaction zone and enters the first separation zone, and a second product exits the reaction zone and enters the second separation zone. Distillation occurs simultaneously with the reaction in the reaction chamber. In one preferred aspect of this invention, chloropropyltrichlorosilane is produced by reacting allyl chloride with trichlorosilane

The present application claims priority benefits based on U.S. Provisional Patent Application No. 60/192,575, filed Mar. 28, 2000, which is incorporated by reference herein.

### INTRODUCTION AND BACKGROUND

The invention concerns a method for the preparation of propylsilanes functionalized in the 3 position.

It is known that hydrogen silanes can be reacted with, for example, allyl chloride, in the presence of homogeneous or heterogeneous platinum catalysts, to form 3-chloropropylsilanes. This reaction is generally called “hydrosilylation,” and is exemplified in Equation I.

Cl—CH₂—CH═CH₂+HSiCl₃→Cl—CH₂—CH₂—CH₂—SiCl₃ (I)

One speaks of homogeneous hydrosilylation when soluble platinum compounds—in the simplest case, for example, H₂PtCl₆, are used as catalysts for the reaction (see DE-OS 28 51 456; CS-PS 176 910; U.S. Pat. No. 4,292,433; U.S. Pat. No. 4,292,434; DE-AS 11 87 240; and DE-PS 11 65 028, all of which are incorporated herein by reference). In the case of heterogeneous hydrosilylation, elemental platinum or platinum compounds on a carrier are used as the reaction catalysts (see U.S. Pat. No. 2,637,738; DE-PS 20 12 229; and DE-PS 28 15 316, all of which are incorporated herein by reference).

It is also known that, in the reaction of, for example, allyl chloride with hydrogen silanes to form 3-chloropropylsilanes (e.g., Equation (I) above), a part of the allyl chloride reacts with the hydrogen silane in a secondary reaction to form propene and the chlorosilane corresponding to the pertinent hydrogen silane. See, for example, Equation II.

Cl—CH₂—CH═CH₂+HSiCl₃→CH₃—CH═CH₂+SiCl₄ (II)

Thus, for example, in the reaction of allyl chloride with trichlorosilane, 25-30 mol % of the allyl chloride which is reacted is converted into propene by the secondary reaction shown in Equation (II). An equivalent molar quantity of silicon tetrachloride is formed in this undesired secondary reaction.

The molar ratio of formed chloropropylsilane to silicon tetrachloride is a measure of the selectivity of the reaction. This selectivity typically attains values between 2.33:1 (70% yield, based on allyl chloride) and 3:1 (75% yield).

It is also known that the formation of propene can be reduced by conducting the reaction in a special way. This mode of operation results in the propene quantitatively reacting further with the hydrogen silane to form propylsilanes. Also, with reactions carried out under normal pressure, in the usual manner, the propene originating from the secondary reaction is reacted to a considerable extent in another secondary reaction with hydrogen silane to form the corresponding propylsilanes (see also DE 34 04 703 C, incorporated herein by reference). See, for example, Equation III.

CH₃—CH═CH₂+HSiCl₃→CH₃—CH₂—CH₂—SiCl₃ (III)

Thus, for example, in an industrial unit with a heterogenous catalytic reaction of allyl chloride and trichlorosilane in a column filled with platinized activated charcoal, up to 230 kg propyltrichlorosilane are obtained per 1000 kg 3-chloropropyltrichlorosilane. That means an additional approximately 28% trichlorosilane starting material is needed, with reference to the trichlorosilane quantity which went into the target product (see also DE 41 19 994 A1, incorporated herein by reference), in order to make up for the trichlorosilane used up in producing the undesired side products (e.g., propylsilanes).

The known methods have the disadvantage that, on the one hand, there is a need for additional hydrogen silane reactant, and, on the other hand, the undesired propylsilanes are difficult to separate. In addition, there is the fact that there are no areas of application for these undesired secondary compounds, and cost-intensive means must be used in order to dispose of them.

From document EP-A 0 519 181, which is incorporated herein by reference, the use of allyl chloride in excess for the preparation of 3-chloropropylsilane is known. The known method has the disadvantage that the reaction mixture, which must be processed by distillation, contains undesirable quantities of allyl chloride.

Thus, an object of this invention is to find a method for the preparation of 3-chloropropyltrichlorosilane which does not exhibit this disadvantage.

### SUMMARY OF THE INVENTION

The present invention relates to a method for preparing an organosilane functionalized in the 3 position. This process includes reacting an allyl compound according to formula I:

H₂C═CH—CH₂X (I),

wherein X is selected from the group consisting of Cl, Br, I, F, CN, SCN, SH, SR, OH, NRR¹ and OR, wherein R and R¹, independent of one another, are selected from the group consisting of (C₁-C₆)alkyl or (C₃-C₇)allyl,

with a silane according to formula II:

R²R³R⁴SiH (II)

wherein R², R³, R⁴, independent of one another, are selected from the group consisting of hydrogen, halogen, (C₁-C₆)alkyl, (C₁-C₆)haloalkyl, (C₃-C₆)allyl, (C₁-C₄)alkoxy, phenyl, aryl, or aralkyl,

wherein the reaction takes place in a reaction column under a pressure between 1 bar and 25 bar, in the presence of a heterogeneous platinum catalyst.

Preferably, the reaction column includes a reaction zone, a first separation zone located above the reaction zone, and a second separation zone located below the reaction zone, wherein a first product exits the reaction zone and enters the first separation zone, and a second product exits the reaction zone and enters the second separation zone. With such a reaction column, distillation takes place simultaneously with the reaction in the reaction column.

In accordance with the invention, the silane reactant is present in the reaction column, and introduced into the reaction column, in a stoichiometric excess with respect to the allyl compound.

In the process according to the invention, unreacted silane present in a first product from the reaction zone (or from the first separation zone) may be condensed and at least a portion of the condensed unreacted silane may then be reintroduced into the reaction zone (preferably via the first separation zone). Also, a portion of the second product from the reaction zone (or from the second separation zone) may be vaporized and at least a portion of the vaporized stream may then be reintroduced into the reaction zone (preferably via the second separation zone).

In a particularly preferred embodiment of the invention, the allyl compound starting material is an allyl halide, preferably allyl chloride (“ACL”), and the silane compound starting material is a trihalosilane, preferably trichlorosilane (“TCS”). When allyl chloride and trichlorosilane are used as the starting reactants, the desired end product prepared is chloropropyltrichlorosilane (“CLPTS”).

### BRIEF DESCRIPTION OF THE DRAWINGS

The present invention will be further understood with reference to the drawings, in which:

FIG. 1 depicts schematically the method of the claimed invention; and

FIG. 2 depicts an exemplary execution of the method of the invention, in which temperature, pressure, and throughflow of the incoming and outgoing substance flows of the reaction column are shown.

### DETAILED DESCRIPTION OF THE INVENTION

Reaction columns useful for the process according to the invention are known from Ullmann's Encyclopedia of Industrial Chemistry, Vol. 34, p. 321 et seq. (1992), which is incorporated herein by reference.

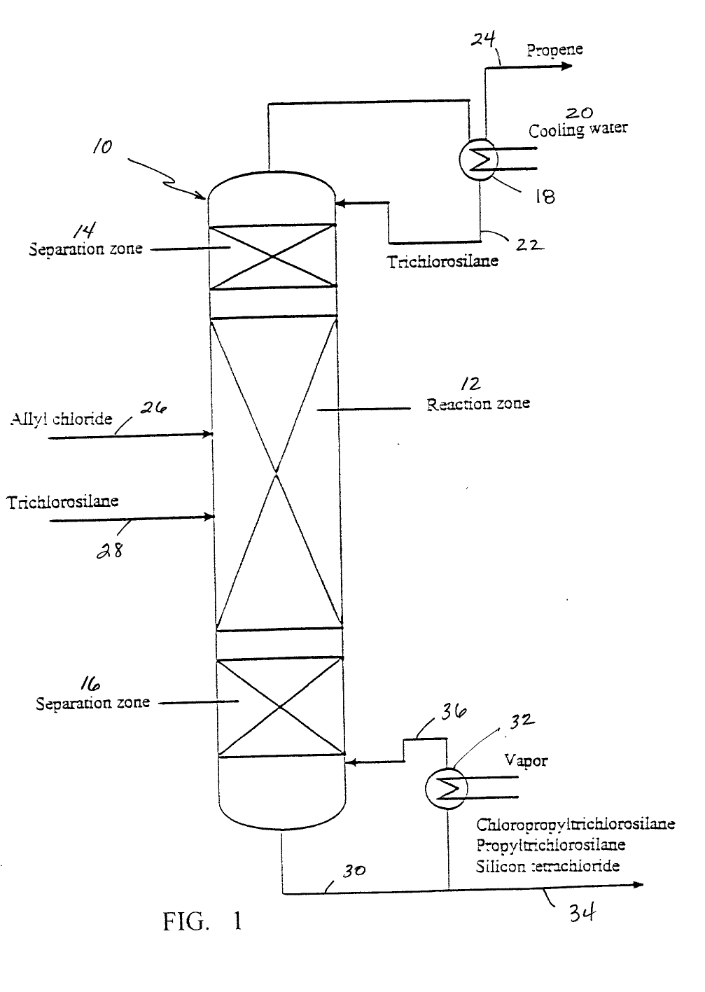

One advantageous feature of the reaction column used in the process of the invention is that the chemical reaction is carried out simultaneously with the first step of the subsequent processing by distillation, in a column. By using such a reaction column, investment costs are reduced. As shown in FIG. 1, the reactor column 10 includes a reaction zone 12, a first separation zone 14 located above the reaction zone 12, and a second separation zone 16 located below the reaction zone 12, wherein a first product exits the reaction zone 12 and enters the first separation zone 14, and a second product exits the reaction zone 12 and enters the second separation zone 16. With such a reaction column, distillation takes place simultaneously with the chemical reaction in the reaction column.

The first product enters the first separation zone 14 where initial separation occurs, and the resulting product, which contains trichlorosilane and propene, leaves the first separation zone 14 and is introduced into a condenser 18. The condenser 18 is cooled in any suitable, for example, using a cooling water loop 20. From the condenser 18, unreacted trichlorosilane is returned to the reactor column 10 via line 22 (preferably at the first separation zone 14), and the propene product is removed via line 24.

As further illustrated in FIG. 1, the trichlorosilane and allyl chloride starting reagents are supplied to the reaction zone 12 of the reaction column 10 via input lines 26 and 28, respectively. The reaction zone 12 is provided with a conventional heterogeneous platinum containing catalyst packing. Any suitable catalyst for the desired reaction and any suitable packing configuration can be used without departing from the invention. Trichlorosilane is added in excess during the start-up. After it has accumulated in the head of the reaction column 10, the ratio of the stoichiometric quantity corresponds to the reactions participating in the conversion. In this way, it is no longer necessary for the trichlorosilane to be separated via additional distillation columns. A very high trichlorosilane excess can be attained by means of this procedure, and the heat of reaction can be used for the evaporation, which will be described in more detail below.

After reacting in the reaction zone 12, the second product mentioned above exits the reaction zone 12 and enters the second separation zone 16. A product from the second separation zone 16 leaves the second separation zone 16 and the reactor column 10 via line 30. A portion of the product from product line 30 is introduced into an evaporator 32 and then reintroduced into the reactor column 10 (preferably through the second separation zone 16) via recycle line 36. While the evaporator 32 can be heated in any appropriate manner, as noted above, preferably heat generated during the chemical reactions taking place in the reaction zone 12 can be used to heat the evaporator 32. The portion of the product line 30 not introduced into the evaporator 32 is removed as product via final product line 34. This product line 34 contains mainly chloropropyltrichlorosilane, and may also contain by-products, such as propyltrichlorosilane and silicon tetrachloride. If necessary or desired, the product in product line 34 may be subjected to further processing, such as separation or purification processes.

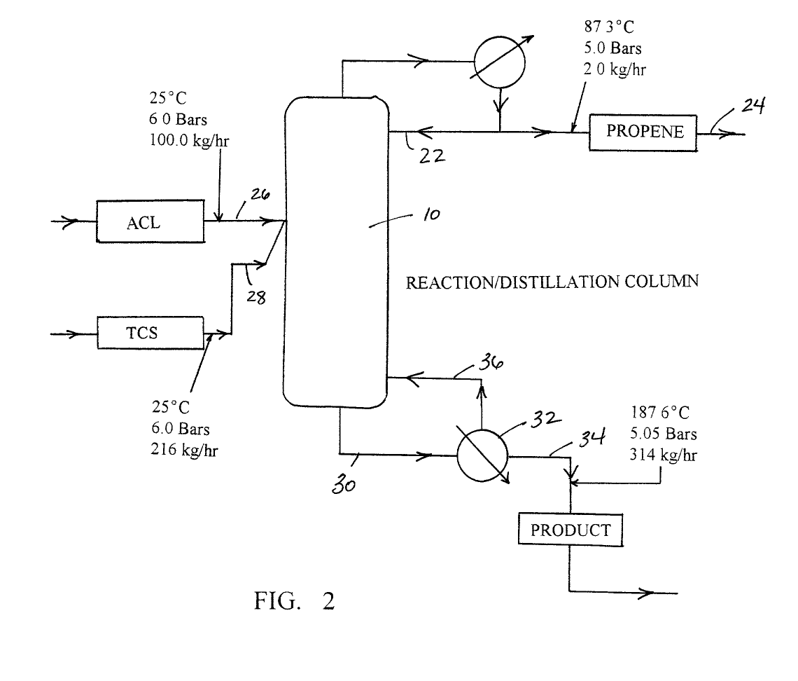

FIG. 2 also illustrates an example of the method of the invention. In this figure, temperature, pressure, and throughflow of the incoming and outgoing substance flows of the reaction column 10 are shown. In the example illustrated in FIG. 2, the product stream 30 is introduced into the evaporator 32, and separation into a recycle stream 36 and product stream 34 occurs at the evaporator 32.

At a pressure of 5 bar_{abs}, a temperature profile which is sufficient for the reaction is established between 85° C. and 190° C. along the reaction column 10, preferably between 90° C. and 190° C. The main reaction zone on plates 7 and 8 in the column 10 shows a slight elevation in temperature. The molar concentration and mass per unit weight show that allyl chloride is completely reacted and a high excess of trichlorosilane can be attained on each theoretical plate of the reaction column 10.

The values for the individual theoretical plates of the reaction column 10, wherein plate 1 indicates the condenser and plate 16 the evaporator, are shown in Tables I and II.

TABLE 1

| | | | | Liquid Flow | Vapor Flow | Liquid Feed | Liquid Product |
|---|---|---|---|---|---|---|---|
| Stage | Temp. (° C.) | Pressure (BAR) | Duty (KW) | (kg/h) | (kg/h) | (kg/h) | (kg/h) |
| 1 | 87.311554 | 5.000000 | −90.887062 | 2000.000000 | 0.000000 | 0.000000 | 2.000000 |
| 2 | 87.494766 | 5.003333 | 0.000000 | 2001.633789 | 2002.000000 | 0.000000 | 0.000000 |
| 3 | 87.792549 | 5.006667 | 0.000000 | 2004.358887 | 2003.633789 | 0.000000 | 0.000000 |
| 4 | 88.286095 | 5.010000 | 0.000000 | 2008.849854 | 2006.358887 | 0.000000 | 0.000000 |
| 5 | 89.119385 | 5.013333 | 0.000000 | 2013.804810 | 2010.849854 | 0.000000 | 0.000000 |
| 6 | 90.809250 | 5.016667 | 0.000000 | 1937.611938 | 2015.804810 | 0.000000 | 0.000000 |
| 7 | 103.560417 | 5.020000 | 0.000000 | 935.114929 | 1939.611938 | 100.000000 | 0.000000 |
| 8 | 103.329338 | 5.023334 | 0.000000 | 940.335876 | 837.112305 | 0.000000 | 0.000000 |
| 9 | 100.237350 | 5.026667 | 0.000000 | 1237.758667 | 842.333252 | 216.000000 | 0.000000 |
| 10 | 102.652802 | 5.030000 | 0.000000 | 1252.029419 | 923.756104 | 0.000000 | 0.000000 |
| 11 | 106.117584 | 5.033333 | 0.000000 | 1273.072388 | 938.026733 | 0.000000 | 0.000000 |
| 12 | 110.585350 | 5.036667 | 0.000000 | 1300.201904 | 959.069702 | 0.000000 | 0.000000 |
| 13 | 115.669167 | 5.040000 | 0.000000 | 1322.888916 | 986.199219 | 0.000000 | 0.000000 |
| 14 | 121.776443 | 5.043334 | 0.000000 | 1290.749512 | 1008.886230 | 0.000000 | 0.000000 |
| 15 | 137.059753 | 5.046667 | 0.000000 | 1110.496826 | 976.746887 | 0.000000 | 0.000000 |
| 16 | 187.578125 | 5.050000 | 48.815884 | 314.002625 | 796.4942263 | 0.000000 | 314.002625 |

TABLE II
Liquid Phase Mass Fractions

| Stage | Allyl Chloride | Trichlorosilane | Silicon Tetrachloride | Propyltrichlorosilane | Chloropropyltrichlorosilane |
|---|---|---|---|---|---|
| 1 | 8.315258E−11 | 0.985670 | 0.014330 | 1.434470E−08 | 4.212395E−13 |
| 2 | 1.238390E−10 | 0.974996 | 0.025003 | 2.072607E−07 | 4.791602E−11 |
| 3 | 1.834647E−10 | 0.956672 | 0.043325 | 2.965420E−06 | 5.388163E−09 |
| 4 | 2.694364E−10 | 0.925723 | 0.074235 | 4.178848E−05 | 5.952588E−07 |
| 5 | 3.218061E−08 | 0.874520 | 0.124848 | 5.734813E−04 | 5.857088E−05 |
| 6 | 3.855338E−06 | 0.785519 | 0.201808 | 0.007409 | 0.005261 |
| 7 | 3.448435E−04 | 0.477898 | 0.225995 | 0.055633 | 0.240129 |
| 8 | 1.124564E−06 | 0.482808 | 0.225414 | 0.053550 | 0.238227 |
| 9 | 4.086832E−09 | 0.531423 | 0.245938 | 0.041293 | 0.181346 |
| 10 | 1.798244E−11 | 0.446555 | 0.332467 | 0.041389 | 0.179589 |
| 11 | 7.164505E−14 | 0.341412 | 0.439820 | 0.041683 | 0.177084 |
| 12 | 7.778140E−14 | 0.231362 | 0.551711 | 0.042878 | 0.174048 |
| 13 | 7.587603E−14 | 0.137411 | 0.641292 | 0.048920 | 0.172377 |
| 14 | 6.505881E−14 | 0.071324 | 0.665612 | 0.076855 | 0.186209 |
| 15 | 4.055050E−14 | 0.028461 | 0.491229 | 0.151506 | 0.328804 |
| 16 | 1.041760E−14 | 0.005179 | 0.141317 | 0.147762 | 0.705742 |

As illustrated in the data above, an advantage results from the process according to the invention in that the selectivity of the reaction (to production of chloropropyltrichlorosilane) is substantially improved. The improved selectivity occurs because of the very high excess of trichlorosilane appearing along the column. The fraction of undesired propyltrichlorosilane can be kept very low in this way.

More specifically, in the example described above, the mass or weight ratio of chloropropyltrichlorosilane to propyltrichlorosilane at the last stage (evaporator stage 16) is 0.705742/0.147762, or about 4.8. Preferably, this ratio is at least 3.5, and more preferably, at least 4.0 or at least 4.5. Similarly, the mass or weight ratio of chloropropyltrichlorosilane to silicon tetrachloride at the last stage is 0.705742/0.141317, or about 5.0. Preferably, this ratio is at least 3.5, and more preferably, at least 4.0 or at least 4.5.

The product mixture exiting the reactor column also is almost entirely free of the allyl chloride starting material (i.e., the mixtures at stages 1, 2, 15, and 16 contain only very small amounts of allyl chloride). Preferably, the amount of allyl chloride exiting the reactor column and present in the final product lines is less than 1% by weight (based on the weight of the relevant product stream), and more preferably less than 0.1% by weight, and even more preferably less than 0.01% by weight. The example described in Table II shows even lower concentrations of allyl chloride in the final product streams, which indicates that this starting material is substantially completely reacted in the reaction column.

While this invention has been described in terms of various preferred embodiments and examples, those of ordinary skill in the art will recognize that various changes and modifications can be made without departing from the spirit and scope of the invention, as defined in the attached claims.

We claim:

1. A method for preparing an organosilane functionalized in the 3 position, comprising: reacting an allyl compound according to formula I:
H₂C═CH—CH₂X (I)
wherein X is selected from the group consisting of Cl, Br, I, F, CN, SCN, SH, SR, OH, NRR¹ and OR, wherein R and R¹, independent of one another, are selected from the group consisting of (C₁-C₆)alkyl or (C₃-C₇)allyl,
with a silane according to formula II:
R²R³R⁴SiH (II)
wherein R², R³, R⁴, independent of one another, are selected from the group consisting of hydrogen, halogen, (C₁-C₆)alkyl, (C₁-C₆)haloalkyl, (C₃-C₆)allyl, (C₁-C₄)alkoxy, phenyl, aryl, or aralkyl,
wherein the reaction takes place in a reaction column under a pressure between 1 bar and 25 bar, in the presence of a heterogeneous platinum catalyst.

2. The method according to claim 1, wherein distillation takes place simultaneously with the reaction in the reaction column.

3. The method according to claim 1, wherein the silane is present in the reaction column in a stoichiometric excess with respect to the allyl compound.

4. The method according to claim 1, wherein the silane is introduced into the reaction column in a stoichiometric excess with respect to the allyl compound.

5. The method according to claim 1, wherein the reaction column includes a reaction zone, wherein a first product exits a first end of the reaction zone and a second product exits a second end of the reaction zone.

6. The method according to claim 5, further comprising condensing unreacted silane in the first product and reintroducing at least a portion of the condensed unreacted silane into the reaction zone.

7. The method according to claim 6, further comprising vaporizing a portion of the second product to form a vaporized stream and reintroducing at least a portion of the vaporized stream into the reaction zone.

8. The method according to claim 5, further comprising vaporizing a portion of the second product to form a vaporized stream and reintroducing at least a portion of the vaporized stream into the reaction zone.

9. The method according to claim 1, wherein the reaction column includes:
a reaction zone, a first separation zone located above the reaction zone, and a second separation zone located below the reaction zone, wherein a first product exits the reaction zone and enters the first separation zone, and a second product exits the reaction zone and enters the second separation zone.

10. The method according to claim 9, further comprising removing unreacted silane from the first separation zone, condensing at least a portion of the unreacted silane, and reintroducing at least a portion of the condensed unreacted silane into the first separation zone.

11. The method according to claim 10, further comprising removing a separated product from the second separation zone, vaporizing at least a portion of the separated product to form a vaporized stream, and reintroducing at least a portion of the vaporized stream into the second separation zone.

12. The method according to claim 9, further comprising removing a separated product from the second separation zone, vaporizing at least a portion of the separated product to form a vaporized stream, and reintroducing at least a portion of the vaporized stream into the second separation zone.

13. A method for preparing chloropropyltrichlorosilane, comprising: reacting ally chloride with trichlorosilane in a reaction column under a pressure between 1 bar and 25 bar, in the presence of a heterogeneous platinum catalyst.

14. The method according to claim 13, wherein distillation takes place simultaneously with the reaction in the reaction column.

15. The method according to claim 13, wherein the trichlorosilane is present in the reaction column in a stoichiometric excess with respect to the allyl chloride.

16. The method according to claim 13, wherein the trichlorosilane is introduced into the reaction column in a stoichiometric excess with respect to the allyl chloride.

17. The method according to claim 13, wherein the reaction column includes a reaction zone, wherein a first product exits a first end of the reaction zone and a second product exits a second end of the reaction zone.

18. The method according to claim 17, further comprising condensing unreacted trichlorosilane and reintroducing at least a portion of the condensed unreacted trichlorosilane into the reaction zone.

19. The method according to claim 18, further comprising vaporizing a portion of the second product to form a vaporized stream and reintroducing at least a portion of the vaporized stream into the reaction zone.

20. The method according to claim 17, further comprising vaporizing a portion of the second product to form a vaporized stream and reintroducing at least a portion of the vaporized stream into the reaction zone.

21. The method according to claim 13, wherein the reaction column includes:
a reaction zone, a first separation zone located above the reaction zone, and a second separation zone located below the reaction zone, wherein a first product exits the reaction zone and enters the first separation zone, and a second product exits the reaction zone and enters the second separation zone.

22. The method according to claim 21, further comprising removing unreacted trichlorosilane from the first separation zone, condensing at least a portion of the unreacted trichlorosilane, and reintroducing at least a portion of the condensed unreacted trichlorosilane into the first separation zone.

23. The method according to claim 22, further comprising removing a separated product from the second separation zone, vaporizing at least a portion of the separated product to form a vaporized stream, and reintroducing at least a portion of the vaporized stream into the second separation zone.

24. The method according to claim 21, further comprising removing a separated product from the second separation zone, vaporizing at least a portion of the separated product to form a vaporized stream, and reintroducing at least a portion of the vaporized stream into the second separation zone.
